(19) United States
(12) Patent Application Publication
(10) Pub. No.: US 2023/0209113 A1
(43) Pub. Date: Jun. 29, 2023

(54) PREDICTIVE CUSTOMER EXPERIENCE MANAGEMENT IN CONTENT DISTRIBUTION NETWORKS

(71) Applicant: AT&T Intellectual Property I, L.P., ATLANTA, GA (US)

(72) Inventors: Xiaowen Mang, Morganville, NJ (US); Gregory Smith, Shrewsbury, NJ (US); Peni-Taito Payne, Katy, TX (US); Michael Lange, Wall, NJ (US); Carolyn Roche Johnson, Holmdel, NJ (US)

(21) Appl. No.: 17/646,282

(22) Filed: Dec. 28, 2021

(51) Int. Cl. H04N 21/24; H04N 21/266; H04N 21/25

(52) U.S. Cl. CPC H04N 21/2402; H04N 21/266; H04N 21/251

(57) ABSTRACT

Devices, computer-readable media, and methods for predictively managing the customer experience in a content distribution network are disclosed. In one example, a method includes acquiring a system log from a component of a content distribution network, detecting an event in a report derived from the system log that has been correlated with a decline in a key performance indicator of the content distribution network, and initiating a corrective action in response to the detecting.

The present disclosure relates generally to content distribution networks (CDNs), and more particularly to devices, non-transitory computer-readable media, and methods for performing predictive, proactive management of the customer experience in CDNs in an automated manner.

### BACKGROUND

A content distribution network (CDN) is a geographically distributed network of proxy servers and their data centers. A CDN provides high availability and performance by distributing a content-oriented service spatially relative to end users. For instance, an origin server may host between 10,000 and 100,000 video programs (or other types of content), where each video program may comprise 10,000 to 60,000 component files (or video “chunks”) based on the video runtime. By comparison, an edge server (or “edge cache”) typically holds far fewer files serving multiple tenants' file delivery purposes, including adaptive bitrate streaming video programs, as well as other file types (such as webpages, documents, and the like). By delivering cached video data to end users from the edge servers (which are physically located closer to the end users than the origin servers), a CDN can provide better customer experience (e.g., shorter startup time, less video buffering ratio, etc.) than if the video data were delivered directly from the origin servers to the end users.

### SUMMARY

In one example, the present disclosure describes devices, computer-readable media, and methods for predictively managing the customer experience in a content distribution network. For instance, in one example, a method includes acquiring a system log from a component of a content distribution network, detecting an event in a report derived from the system log that has been correlated with a decline in a key performance indicator of the content distribution network, and initiating a corrective action in response to the detecting.

In another example, a non-transitory computer-readable medium stores instructions which, when executed by a processing system including at least one processor, cause the processing system to perform operations. The operations include acquiring a system log from a component of a content distribution network, detecting an event in a report derived from the system log that has been correlated with a decline in a key performance indicator of the content distribution network, and initiating a corrective action in response to the detecting.

In another example, a system includes a processing system including at least one processor and a computer-readable medium storing instructions which, when executed by the processing system, cause the processing system to perform operations. The operations include acquiring a system log from a component of a content distribution network, detecting an event in a report derived from the system log that has been correlated with a decline in a key performance indicator of the content distribution network, and initiating a corrective action in response to the detecting.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example system in accordance with the present disclosure;

FIG. 3 illustrates a flowchart of an example method for training a system to perform predictive management of the customer experience in a content distribution network;

FIG. 4 illustrates a flowchart of an example method for predictively managing the customer experience in a content distribution network, in accordance with the present disclosure;

FIG. 5 illustrates an example workflow diagram for predictively managing the customer experience in a content distribution network; and

FIG. 6 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe devices, non-transitory computer-readable media, and methods for performing predictive, proactive management of the customer experience in CDNs in an automated manner. As discussed above, a CDN provides high availability and performance by delivering cached content to customers from edge servers rather than directly from the origin servers which host the content. Customer experience while consuming content via a CDN can be characterized by various key performance indicators (KPIs) that measure the quality of the content and/or experience of consuming the content. For instance, KPIs for streaming video over a CDN might include how long it takes for the video to start (i.e., video startup time), how frequently the video stalls, or how often videos fail to start, among other KPIs.

Various conditions within the CDN, such as connectivity, traffic, placement of one or more network elements (e.g., origin servers, cache servers, or the like), and the like may negatively impact the KPIs, which may translate into a poor customer experience. In such instances, the CDN provider may take corrective measures to adjust the conditions within the CDN and improve the customer experience. Typically, however, the CDN provider is not aware of the decline in the customer experience until the customer experience has already noticeably worsened (or until customers complain). Thus, even when the CDN provider is relatively quick to take corrective measures, customers may still experience a period of poor service. Moreover, determining the root cause of the decline (and, thus, the appropriate corrective measure) is a primarily manual process that involves reviewing various network management systems and collected data.

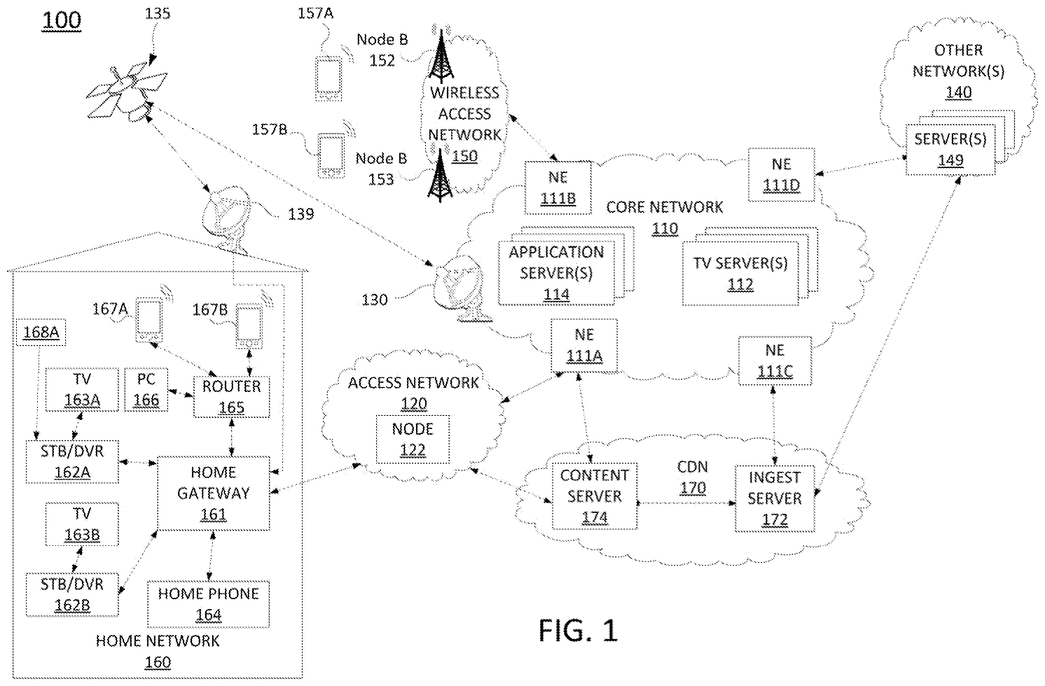

Examples of the present disclosure manage the customer experience in a CDN in an automated, predictive, and proactive manner. In particular, examples of the present disclosure enable conditions that may lead to poor customer experience to be detected earlier, and in some cases even before customers notice a decline in the customer experience. In one example, content routing logs collected from domain name server (DNS)-based content routers and content access logs collected from cache servers may be correlated, using machine learning techniques, with various KPIs to establish links between events occurring in the content routing logs and content access logs and declines in customer experience. Subsequently, when these events are detected in the content routing logs and/or content access logs, detection may trigger a corrective action to minimize any decline in the customer experience that may be indicated by the events. These and other aspects of the present disclosure are described in greater detail below in connection with the examples of FIGS. 1-6.

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140, content distribution network (CDN) 170, and/or the Internet in general. For instance, connections between core network 110, access network 120, home network 160, CDN 170, and other networks 140 may comprise the Internet in general, internal links under the control of single telecommunication service provider network, links between peer networks, and so forth.

In one embodiment, wireless access network 150 comprises a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), “fifth generation” (5G), Long Term Evolution (LTE) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by a same entity as core network 110.

In one example, each of the mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, any one or more of the mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, wireless access network 150, access network 120, and so forth. As shown in FIG. 1, core network 110 may also include a plurality of television (TV) servers 112, and a plurality of application servers 114. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may include content server(s) to store scheduled television broadcast content for a number of television channels, video-on-demand programming, local programming content, and so forth. Alternatively, or in addition, content providers may stream various contents to the core network 110 for distribution to various subscribers, e.g., for live content, such as news programming, sporting events, and the like. Television servers 112 may also include advertising server(s) to store a number of advertisements that can be selected for presentation to viewers, e.g., in the home network 160 and at other downstream viewing locations. For example, advertisers may upload various advertising content to the core network 110 to be distributed to various viewers. Television servers 112 may also include interactive TV/video-on-demand (VOD) server(s), as described in greater detail below. Although the core network 110 is described as including television servers 112, it will be appreciated that the core network 110 may also include servers for storing other types of content, including non-video content. For instance, the core network 110 may include servers to store audio content (e.g., music, podcasts, audio books, etc.), still images, gaming content, and other types of content.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between home network 160 and core network 110 relating to voice telephone calls, communications with web servers via other networks 140, content distribution network (CDN) 170 and/or the Internet in general, and so forth. In another example, access network 120 may be operated by a different entity from core network 110, e.g., an Internet service provider (ISP) network.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

As illustrated in FIG. 1, core network 110 may include various application servers 114. For instance, application servers 114 may be implemented to provide certain functions or features, e.g., a Serving-Call Session Control Function (S-CSCF), a Proxy-Call Session Control Function (P-CSCF), or an Interrogating-Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. In one example, application servers 114 may include data storage servers to receive and store data structures or directories (e.g., manifest files) regarding content maintained within TV servers 112 and/or available to subscribers of core network 110 and stored in server(s) 149 in other networks 140. It should be noted that the foregoing are only several examples of the types of relevant application servers 114 that may be included in core network 110 for storing information relevant to providing various services to subscribers.

In accordance with the present disclosure, other networks 140 and servers 149 may comprise networks and devices of various content providers (e.g., providers of streaming video and audio content, image content, gaming content, and/or other types of content). In one example, each of the servers 149 may also make available data structures which describe the portions of various content items stored on the respective one of the servers 149.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

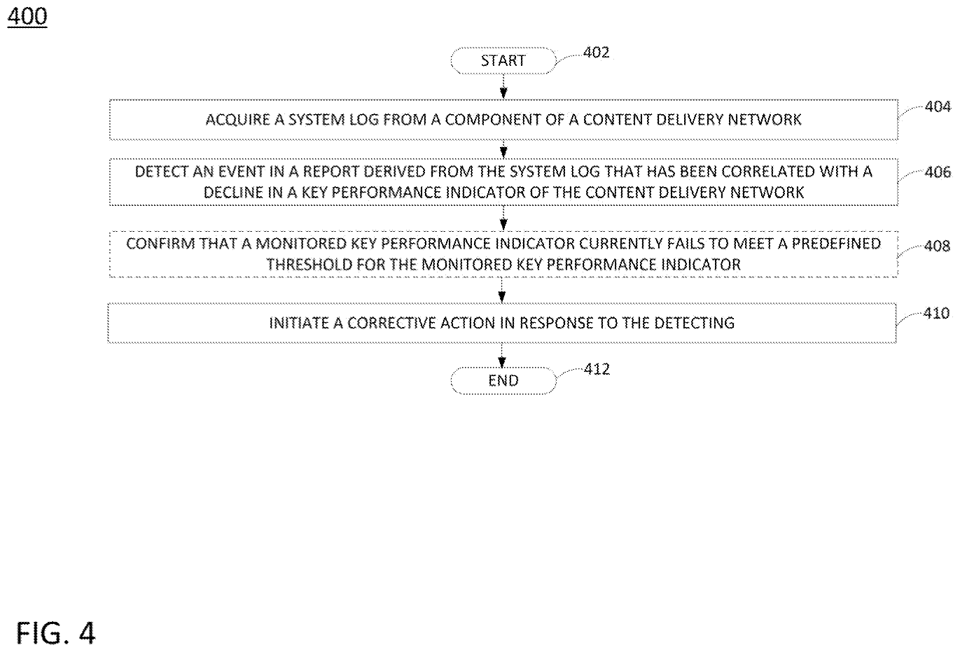

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. A flowchart of an example method of predictively managing the customer experience in a content distribution network is illustrated in FIG. 4 and described in greater detail below. Although STB/DVR 162A and STB/DVR 162B are illustrated and described as integrated devices with both STB and DVR functions, in other, further, and different examples, STB/DVR 162A and/or STB/DVR 162B may comprise separate STB and DVR devices.

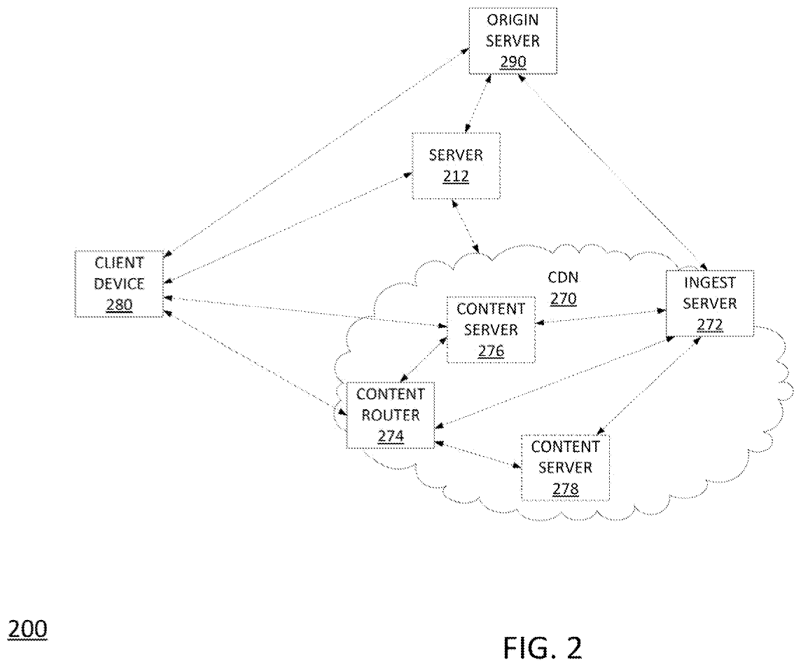

Network 100 may also include a content distribution network (CDN) 170. In one example, CDN 170 may be operated by a different entity from core network 110. In another example, CDN 170 may be operated by a same entity as core network 110, e.g., a telecommunication service provider. In one example, the CDN 170 may comprise a collection of cache servers distributed across a large geographical area and organized in a tier structure. The first tier may comprise a group of servers that access content web servers (origin servers) to pull content into the CDN 170, referred to as an ingest servers, e.g., ingest server 172. The content may include video programs, content of various webpages, electronic documents, video games, etc. A last tier may comprise content servers which deliver content to end users, typically from the edge of the CDN 170, e.g., content server 174. For ease of illustration, a single ingest server 172 and a single content server 174 are shown in FIG. 1. In between the ingest server 172 and content server 174, there may be several layers of content servers (illustrated further in FIG. 2), referred to as the middle tier. In one example, the content server 174 may be multi-tenant, serving multiple content providers, such as core network 110, content providers associated with server(s) 149 in other network(s) 140, and so forth.

As mentioned above, TV servers 112 in core network 110 may also include one or more interactive TV/video-on-demand (VOD) servers. Among other things, an interactive TV/VOD server may function a server for STB/DVR 162A and/or STB/DVR 162B, one or more of mobile devices 157A, 157B, 167A and 167B, and/or PC 166 operating as a client for requesting and receiving a data structure or directory, such as a manifest file, for available content. For example, STB/DVR 162A may present a user interface and receive one or more inputs (e.g., via remote control 168A) for a selecting content for playback on STB/DVR 162A. STB/DVR 162A may request the content from an interactive TV/VOD server, which may retrieve the data structure for the content from one or more of application servers 114 and provide the data structure to STB/DVR 162A. STB/DVR 162A may then obtain portions of the content as identified in the data structure.

In one example, the data structure may direct the STB/DVR 162A to obtain a portion of the content from the content server 174 in CDN 170, which may cache some portions of content. The content server 174 may already store the portions of the content and may deliver the portions of the content upon a request from the STB/DVR 162A. However, if the content server 174 does not already store the portions of the content, upon request from the STB/DVR 162A, the content server 174 may in turn request the portions of the content from an upstream content server (e.g., a mid-tier server or an origin server). The upstream content server which stores portions of the content may comprise, for example, one of the servers 149 or one of TV servers 112. The portions of the content may be obtained from an origin server via ingest sever 172 before passing to content server 174. In one example, the ingest server 172 may also pass the portions of the content to other mid-tier content servers and/or other content routers (not shown) of CDN 170. The content server 174 may then deliver the portions of the content to the STB/DVR 162A and may store the portions of the content until the portions of the content are removed or overwritten from the content server 174 according to any number of criteria, such as a least recently used (LRU) algorithm for determining which content to keep in the content server 174 and which content to delete and/or overwrite.

It should be noted that a similar process may involve other devices, such as TV 163A or TV 163B (e.g., “smart” TVs), mobile devices 167A, 167B, 157A or 157B obtaining a data structure for content from one of TV servers 112, from one of servers 149, etc., and requesting and obtaining portions of the content from content server 174 of CDN 170. In this regard, it should be noted that content server 174 may comprise a device that is closest to the requesting device geographically or in terms of network latency, throughput, etc., or which may have more spare capacity to serve the requesting device as compared to other edge devices, which may otherwise best serve the content to the requesting device. However, depending upon the location of the requesting device, the access network utilized by the requesting device, and other factors, the portions of the content may be delivered via various networks, various links, and/or various intermediate devices. For instance, in one example, content server 174 may deliver portions of content to a requesting device in home network 160 via access network 120, e.g., an ISP network. In another example, content server 174 may deliver portions of the content to a requesting device in home network 160 via core network 110 and access network 120. In still another example, content server 174 may deliver portions of the content to a requesting device such as mobile device 157A or 157B via core network 110 and wireless access network 150.

Further details regarding the functions that may be implemented by content server 174, are discussed in greater detail below in connection with the examples of FIGS. 2-5. In addition, those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

FIG. 2 illustrates an example system 200 according to the present disclosure. As illustrated in FIG. 2, the system 200 includes a content distribution network (CDN) 270, a client device 280, and an origin server 290. The CDN 270 may be the same or similar to the CDN 170 in FIG. 1. The client device 280 may comprise any number of devices such, as a set-top box (STB), a smart TV, a desktop computer, a laptop computer, a tablet, a smartphone, or the like that includes functionality of an adaptive bitrate streaming video client. The origin server 290 may be operated by a same entity or a different entity as CDN 270 and may store various content for delivery to customers using client devices such as the client device 280. For instance, the origin server 290 may store a plurality of video chunks for each of a plurality of segments of a video program. In one example, the origin server 290 may also store and make available data structures or directories (e.g., manifest files) for different content. In another example, the origin server 290 may create such data structures in response to a request for content from a particular client device. For instance, a different data structure may be provided to client device 280 as compared to a different client device, e.g., depending upon the capabilities of the client device 280, based upon rights of the client device according to a subscription, purchase or rental of the content, based upon a location of the client device 280, based upon the availability and/or capability of CDN 270 and/or content router 274, and so forth. In another example, client device 280 may obtain a data structure for content from a different source, such as server 212. For instance, server 212 may be operated by a telecommunication service provider or streaming video service provider of which a user of client device 280 is a subscriber, while origin server 290 may be associated with a content creator and/or content provider, such as a network providing broadcast and on-demand programming to subscribers of the telecommunication service provider network and/or streaming video service provider.

In one example, the manifest file or other data structures associated with content stored on the origin server 290 may direct client device 280 to obtain portions of the content (e.g., video chunks of a video program) from content server 276 or 278, which may or may not already have stored copies of the portions of the content. A manifest file, for example, may provide uniform resource locators (URLs) and/or uniform resource identifiers (URIs) for different video chunks which resolve to the content servers 276 or 278. Thus, the client device 280 may obtain the video chunks from content servers 276 or 278. In the absence of a manifest file, the client device 280 may direct queries for content to the content router 274. In one example, the content router 274 functions in a manner similar to a DNS server. Thus, the client device 280 may send a query for content to the content router 274, which may, in response to the query, return to the client device 280 the IP address of a content server (e.g., content server 276 or 278) from which the client device 280 may acquire the requested content.

An example of client device 280 obtaining and playing content via the CDN 270 may proceed as follows. Client device 280 may have an application to browse and select content that is being made available by origin server 290 and/or server 212. In response to a selection of a particular content item, origin server 290 or server 212 may provide a data structure (e.g., a manifest file) for the content to client device 212. For purposes of the present example, the data structure may provide URLs for different portions of the content which resolve to the content servers 276 and 278. Alternatively, or in addition, the data structure may provide URIs for different portions of the content along with instructions directing the client device 280 to request the files associated with the URIs from content servers 276 and 278. Alternatively or in addition, the client device 280 may query the content router 274 for a particular content item, and the content router 274 may respond to the client device's query with the IP address of the content server (e.g., content server 276 or 278) that is believed to have stored thereon the particular content item.

For instance, the content router 274 may believe (e.g., based on resolution of a previous query for the particular content item) that content server 276 stores one or more portions of the content. However, content server 276 may or may not store one or more portions of the content. In particular, content server 276 may have a limited capacity and cannot store all content that may be requested by client devices that may be serviced by the content server 276. For instance, content server 276 may evict stale content via a least recently used (LRU) algorithm or the like. When initially receiving the data structure or response from the content router 274, the client device 280 may request one or more portions of the content from the content server 276.

In response to the request for one or more portions of the content, the content server 276 may first determine whether the requested portions of the content are available at the content server 276. If the content server 276 already stores a requested portion of the content, the content server 276 may deliver the portion of the content to the client device 280. If the content server 276 does not possess a requested portion of the content, the content server 276 may request the portion of the content from the CDN 270 and/or from the origin server 290. For instance, the content server 276 may transmit a request to origin server 290 for the portion of the content. In one example, the request may pass via ingest server 272 and/or one or more mid-tier servers (not illustrated). In one example, the request may be intercepted by one of the mid-tier servers or ingest server 272. If the intercepting device has stored thereon a copy of the requested portion of the content, the intercepting device may return the portion of the content to content server 276 in response to the request. Otherwise, the request may be passed to the origin server 290.

In another example, a content server 276 may broadcast a request to peer-devices within CDN 270 to determine a closest copy of the portion of the content. The content server 276 may then obtain the portion of the content from any responding device of the CDN, such as a mid-tier server, another edge device, ingest server 272, etc. If, however, there is no device of the CDN 270 that responds, the content server 276 may then send the request to origin server 290. In one example, the origin server 290 may return the requested portion(s) of the content to ingest server 272, which may forward the portion(s) of the content to content server 276, and which may also store the portion(s) of the content and/or distribute the portion(s) of the content to other devices in CDN 270. For example, the portions(s) of the content may be forwarded to content server 276 via a mid-tier server, which may store the portion(s) of the content before or at the same time as passing the portion(s) of the content to content server 276. Thus, if another content server of CDN 270 requests the same portion(s) of the content, it may be more efficient to obtain the portion(s) of the content from a mid-tier server than to re-populate the portion(s) of the content into CDN 270 from the origin server 290.

In any event, client device 280 may obtain an initial set of one or more files for one or more portions of the content and begin playing the content from the buffer. As the client device 280 plays one or more of the portions of the content, the client device 280 may also obtain additional files for subsequent portions of the content from the content server 276. The content server 276 may again fulfill the request from portions of the content that are already stored at content server 276, or may obtain the portions of the content from other devices in CDN 270 and/or from origin server 290. However, it should be noted that when the portions of the content are not already stored at content server 276, a presentation of the content at client device 280 is more susceptible to a buffer stall, delay, degradation of quality (e.g., dropping to a lower encoding bit rate if the content is video), and so forth. In particular, the number of network hops, e.g., from content server 276 to origin server 290, the distances between such devices and any intermediate devices, and so forth, may all contribute to unanticipated and/or unavoidable delays, congestion, etc.

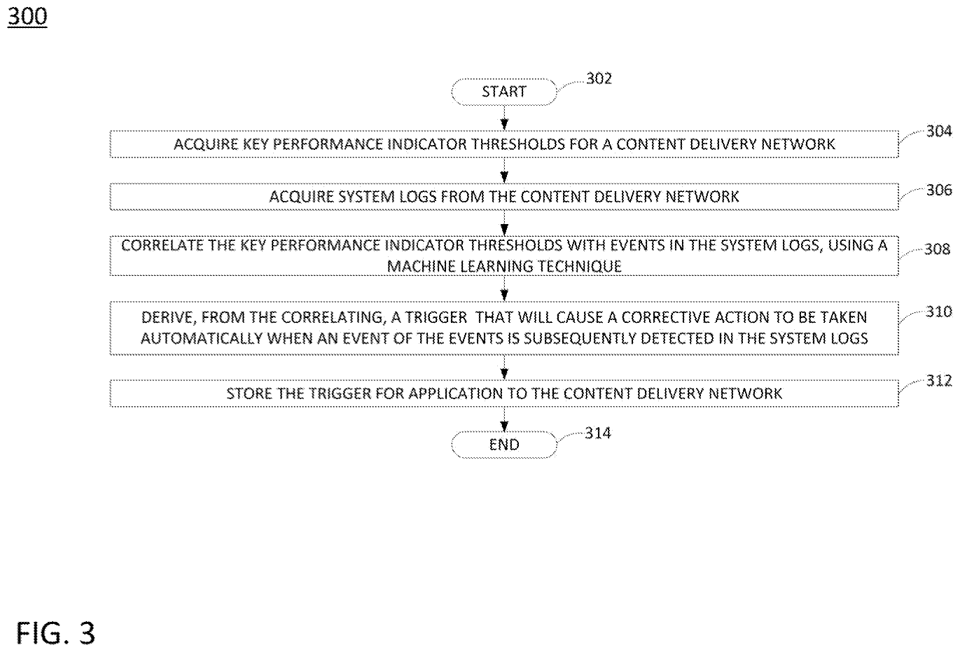

In accordance with the present disclosure, content router 274, content servers 276 and 278, and origin server 290 may, in the course of serving content to customers as discussed above, generate system logs which may be monitored for the occurrence of events which automatically trigger corrective actions to manage the customer experience within the CDN 270. For instance, the content router 274 may generate content routing logs, while the content servers 276 and 278 may generate content server content access logs. As discussed in further detail with respect to FIGS. 3 and 4, reports may be derived from these systems logs. Events detected within these reports may be correlated with thresholds for key performance indicators for the CDN 270, such that when certain events are detected, the onset of a decline in the customer experience can be assumed (potentially before customers notice the decline). Corrective action can then be taken to mitigate the decline in the customer experience before the customer experience worsens noticeably.

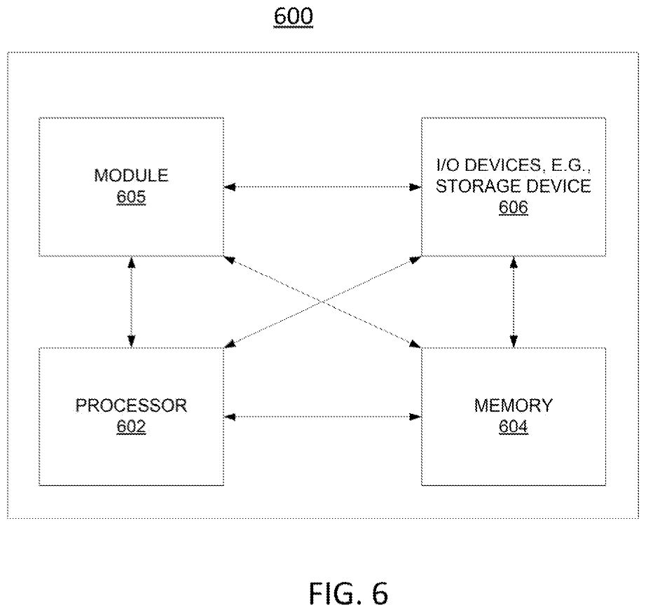

FIG. 3 illustrates a flowchart of an example method 300 for training a system to perform predictive management of the customer experience in a content distribution network, in accordance with the present disclosure. In one example, the method 300 is performed by one of the application servers 114 of FIG. 1, any one or more components thereof (e.g., a processor performing operations stored in and loaded from a memory), or by an application server 114 in conjunction with one or more other devices, such as content server 274, origin server 290, server 212, and so forth. In one example, the steps, functions, or operations of method 300 may be performed by a computing device or system 600, and/or processor 602 as described in connection with FIG. 6 below. For instance, the computing device or system 600 may represent any one or more components of an application server or client device in FIG. 1 or FIG. 2 that is/are configured to perform the steps, functions and/or operations of the method 300. For illustrative purposes, the method 300 is described in greater detail below in connection with an example performed by a processing system.

The method 300 begins in step 302 and proceeds to step 304. In step 304, the processing system may acquire key performance indicator thresholds for a content distribution network. Key performance indicators may provide some measure or quantification of the actual customer experience provided by the CDN. For example, for video content, key performance indicators may include video startup time (i.e., how much time it takes for the video to start playing after the customer has clicked on the selected content), rebuffering ratio (i.e., percentage of time the video was rebuffering out of the total actual playing time), average bitrate per video, video resolution, video latency, and/or other metrics.

In one example, the CDN provider may define the KPIs that are most closely associated with the customer experience for the particular CDN. For the purposes of monitoring the customer experience, the CDN provider may provide thresholds for the KPIs, such that when a KPI being measured fails to meet the associated threshold (e.g., falls below or exceeds the threshold, depending on the KPI), poor customer experience can be assumed. In one example, the appropriate threshold for each KPI may be determined by analyzing historical KPI measurements and correlating the historical KPI measurements with reported instances of poor customer experience. In a further example, an anomaly detection engine operated by the CDN provider may examine historical KPI measurements, customer feedback (e.g., reported instanced of poor customer experience), and industry standards when determining the thresholds for anomalies, or actionable decline in customer experience.

In step 306, the processing system may acquire system logs for the content distribution network. In one example, the system logs may include content routing logs and content access logs. The content routing logs may be acquired from DNS-based content routers of the CDN. The content routing logs may comprise records of content requests flowing through the content routers. The content access logs may be acquired from the content servers (e.g., edge and/or mid-tier servers) of the CDN. The content access logs may comprise records of content requests served by the content servers.

In step 308, the processing system may correlate the key performance indicator thresholds with events in the system logs, using a machine learning technique. For instance, existing deep neural network (DNN) learning techniques may be well-suited to correlating the KPI thresholds and events in the system logs. In one example, correlating the KPI thresholds with the events in the system logs may first involve deriving one or more reports from the system logs. For instance, from the content routing logs, at least two reports may be derived: a first report that indicates the performance of the content routers (also referred to herein as a “content router load report”) and a second report that indicates how content streaming requests are distributed across content server clusters (also referred to herein as a “CDN server load report”).

Generally, a successful DNS query for CDN services will return an IP address of a content server from which requested content can be streamed to a user endpoint device. By correlating content routing logs with the CDN provider's content server IP address list, the CDN server load report can be obtained as a distribution of the number of queries across the content server sites. Moreover, any content server site will typically host multiple content servers, and similar statistics can be obtained from the content server access logs (in which each content server logs each content request received by the content server). The CDN provider may elect to utilize the content routing logs, the content access logs, or both the content routing logs and the content access logs to generate the CDN server load report. The decision as to which log(s) to utilize may depend upon data collection, a reporting granularity, data access solutions, and availability of associated information which can be helpful in localizing potential root causes of declines in KPIs. A CDN server load report derived from content routing logs may provide insight into content load dynamics per content server in terms of, for instance, number of content playing requests per unit of time (e.g., per minute).

Moreover, because DNS-based content routers are on the critical path for a successful content playback experience, an understanding of the relationship between the content router health and content playback experience may help to predict the onset of a decline in a KPI. The content router load report may report query request dynamics in terms of success or failure. A spike in content router query request failure rates (e.g., an increase of more than a threshold amount over a defined window of time) may lead to an increase in customer dissatisfaction.

From the content server content access logs, at least two reports may also be derived: a first report that indicates content download times from upstream content servers (e.g., mid-tier servers and/or origin servers) to edge servers (also referred to herein as a “content download time report”) and a second report that indicates why particular requests to retrieve content from edge servers and/or mid-tier servers did not perform as the requests were expected to perform (also referred to herein as a “cache log report”).

A content download time report may be used to track the health of communications between mid-tier servers and other mid-tier servers, between mid-tier servers and edge caches, and between origin servers and mid-tier servers. For instance, a significant increase in content download time (e.g., more than a threshold increase within a defined window of time) may be indicative of network connectivity issues or failures of upstream servers.

A cache log report may be used to track the health of caching policies at mid-tier servers and edge caches. For instance, if content retrieval requests to a specific server (e.g., edge cache, mid-tier server, or origin server) are repeatedly (e.g., more than a threshold number of times within a defined window of time) redirected to upstream servers, this may indicate that the current cache size of the specific server is too small, and, thus, content is being evicted from the cache too quickly (and therefore resulting in increased traffic to upstream servers, which defeats the purpose of utilizing downstream cache). In this context, “too small” could mean that the cache is not sized appropriately despite a CDN provider's best efforts (e.g., potentially due to the CDN provider fine-tuning the CDN configuration), that the CDN content access patterns are too sparse (e.g., potentially due to the sets of cacheable content being very large) to easily derive a single cache policy, or that other issues may necessitate a review of the caching policies.

Content server content access logs may also contain information about whether cached content is refreshed in the proper manner. When cached content is not refreshed within the proper amount of time, outdated content may end up being streamed (if the CDN provider allows stale content to be served from the servers), or customers may experience prolonged re-buffering or timeout operations (if the CDN provider does not allow stale content to be served). The root cause of untimely content refresh operations is often the failure of an origin server; thus, analysis of content access log reports may help to detect origin server failures. The use of content server content access logs to detect origin server failures may prove especially useful in cases where a CDN provider does not own the origin server that is failing, as the ability to quickly identify a third-party origin server as the root cause of a detected issue may allow the CDN provider to avoid paying financial penalties for missing service level agreement (SLA) targets due to circumstances outside of the CDN provider's control.

In a further example, the cache results from a content server may also be logged, and the first and second reports may be derived through log aggregation and analysis tools. This approach may reveal larger trends and unearth problems or inefficiencies that would not necessarily result in overt client errors or bug reports from customers.

Once the reports have been derived from the system logs, the reports may be correlated with the KPI thresholds such that events in the reports which are associated with KPI measurements that fail to meet the KPI thresholds can be identified. For instance, a spike in the origin server failure rate or in the number of queries directed to a particular server (e.g., edge cache, mid-tier, or origin server) may be correlated with an increase in timeout operations on customer endpoint devices (which is likely to lead to an increase in customer dissatisfaction). Similarly, a longer content download time from an upstream server to a downstream server may be correlated with longer content startup times or higher content rebuffering ratios, which may also lead to an increase in customer dissatisfaction.

In one example, learned correlations between the reports derived from the system logs and the KPI thresholds may be associated with time signatures. For instance, the number of queries directed to a particular server may vary throughput the day (e.g., may be significantly higher at certain times than at other times). In this case, a higher number of queries observed during a time period when the number of queries is historically significantly lower (e.g., lower by a threshold percentage) may be correlated with a KPI threshold (which may indicate a network problem or a failure at another server).

In step 310, the processing system may derive, from the correlating, a trigger that will cause a corrective action to be taken automatically when an event of the events is subsequently detected in the system logs. For instance, if a spike in the origin server failure rate or in the number of queries directed to a particular server (e.g., edge cache, mid-tier, or origin server) has been correlated with an increase in timeout operations on customer endpoint devices, a trigger may be derived such that when a spike in the origin server failure rate or in the number of queries directed to a particular server is observed in reports derived from the system logs, an associated corrective action (e.g., reevaluating placement of servers) is automatically initiated. Similarly, if a content download time that is longer than a threshold between an upstream server and a downstream server has been correlated with longer content startup times or higher content rebuffering ratios, a trigger may be derived such that when a content download time that is longer than the threshold between the upstream server and the downstream server is observed in reports derived from the system logs, an associated corrective action (e.g., reevaluating the CDN caching policy) is automatically initiated.

In step 312, the processing system may store the trigger for application to the content distribution network. In one example, the trigger may be stored to a device or application that is responsible for monitoring and managing the customer experience within the CDN (such as an application server). For instance, the device or application may perform the operations of the method 400, described in further detail below.

The method 300 may end in step 314.

It should be noted that as the network and traffic dynamics change over time, it may be prudent to repeat the method 300. For instance, the method 300 may be periodically invoked to reevaluate the learned correlations between the events in the system logs and the KPI thresholds. In one example, the method 300 may be repeated automatically according to a defined schedule (e.g., every x days, every y months, etc.). However, in other examples, the method 300 may be selectively invoked at the discretion of the CDN provider. For instance, certain events such as a change in system configurations at the content routers or content servers may result in a redistribution of traffic or load changes on certain servers in the CDN. In this case, the CDN provider may wish to rerun the method 300 at the earliest possible opportunity, rather than wait for a scheduled repeat of the method 300 (particularly if the next scheduled repeat is not due to occur for some time).

FIG. 4 illustrates a flowchart of an example method 400 for predictively managing the customer experience in a content distribution network, in accordance with the present disclosure. In one example, the method 400 is performed by one of the application servers 114 of FIG. 1, any one or more components thereof (e.g., a processor performing operations stored in and loaded from a memory), or by an application server 114 in conjunction with one or more other devices, such as content router 274, origin server 290, server 212, and so forth. In one example, the steps, functions, or operations of method 400 may be performed by a computing device or system 600, and/or processor 602 as described in connection with FIG. 6 below. For instance, the computing device or system 600 may represent any one or more components of an application server or client device in FIG. 1 or FIG. 2 that is/are configured to perform the steps, functions and/or operations of the method 400. For illustrative purposes, the method 400 is described in greater detail below in connection with an example performed by a processing system.

The method 400 begins in step 402 and proceeds to step 404. In step 404, the processing system may acquire a system log from a component of a content distribution network. For instance, as discussed above, the system log may comprise a content routing log and/or a content access log. Content routing logs may be acquired from DNS-based content routers of the CDN. The content routing logs may comprise records of content flowing through the content routers. Content access logs may be acquired from the content servers (e.g., edge and/or mid-tier servers) of the CDN. The content access logs may comprise records of content requests served by the content servers.

In step 406, the processing system may detect an event in a report derived from the system log that has been correlated with a decline in a key performance indicator of the content distribution network. As discussed above, at least two reports may be derived from the content routing logs: a first report that indicates the performance of the content routers (also referred to herein as a “content router load report”) and a second report that indicates how content streaming requests are distributed across content server clusters (also referred to herein as a “v CDN server load report”). At least two reports may also be derived from the content access logs: a first report that indicates content download times from upstream content servers (e.g., mid-tier servers and/or origin servers) to edge servers (also referred to herein as a “content download time report”) and a second report that indicates why particular requests to retrieve content from edge servers and/or mid-tier servers did not perform as the requests should have (also referred to herein as a “cache log report”).

As also discussed above, during training of a system configured to manage the customer experience, a machine learning technique may be used to learn correlations between events in the reports that are derived from the system logs and KPI measurements that fail to meet predefined thresholds (e.g., that fall below or exceed the predefined thresholds, depending on the KPIs). For instance, a spike in the origin server failure rate or in the number of queries directed to a particular server (e.g., edge cache, mid-tier, or origin server), as detected within a report derived from a content server content access log, may be correlated with an increase in a KPI that tracks timeout operations on customer endpoint devices (which is likely to lead to an increase in customer dissatisfaction). Similarly, a longer content download time from an upstream server to a downstream server, as detected within a report derived from a content server content access log, may be correlated with an increase in a KPI that tracks content startup times or content rebuffering ratios (which may also lead to an increase in customer dissatisfaction).

In optional step 408 (illustrated in phantom), the processing system may confirm that a monitored key performance indicator currently fails to meet a predefined threshold for the monitored key performance indicator. Thus, step 408 may serve as a verification that the KPI measurements that are correlated with the event detected in step 406 are, in fact, being observed in the CDN currently.

Failure of the monitored KPI to meet the predefined threshold may be temporary in some cases. In such cases, the failure of the monitored KPI to meet the predefined threshold may resolve on its own in a relatively short period of time. In such a case, the processing system may determine that no action is currently necessary. However, assuming that the failure of the monitored KPI to meet the predefined threshold is not temporary (e.g., is reflective of a more long-term issue in the CDN), the method 400 may proceed to step 410.

In step 410, the processing system may initiate a corrective action in response to the detecting. In one example, the corrective action to be initiated is determined in accordance with a root cause analysis. In other words, the processing system may determine the root cause of the event that is detected in step 406.

As an example, consider the following four KPIs: video start failure, video startup time, exits before video start, and rebuffering ratio. A spike in video start failure may be associated with events including a spike in the content router load, a spike in the content router failure rate, or a spike in the CDN server load. A spike in video start time may be associated with events including a spike in the content router load, a spike in the content router failure rate, a spike in the CDN server load, or a spike in upstream content requests. A spike in exits before video start may be associated with events including a spike in the CDN server load, a spike in upstream content requests, or a spike in the download time from an upstream content server. A spike in the rebuffering ratio may be associated with events including a spike in the CDN server load, a spike in upstream content requests, a spike in the download time from an upstream content server, or stale content being detected in cache.

If the event is a spike in the content router load or a spike in the content router failure rate, possible root causes could relate to issues with a content router, a CDN server, a network outage, or a peering link failure. If the event is a spike in the CDN server load, possible root causes could relate to issues with a CDN server, a network outage, or a peering link failure. If the event is a spike in upstream content requests, possible root causes could relate to issues with a CDN server. If the event is a spike in the download time from an upstream content server, possible root causes could relate to issues with a network outage or a peering link failure. If the event is stale content being detected in cache, possible root causes could relate to issues with an origin server.

However, if the event is detected in the content router load report, the most likely KPIs to be affected are video start failure and video startup time. The root cause for a spike in either of these KPIs could relate to a content router, a CDN content server, a network outage, a peering link failure, or other network elements.

If the event is detected in the CDN server load report, the same four KPIs (i.e., video start failure, video startup time, exits before video start, and rebuffering ratio) are most likely to be affected. However, a failure within a content router can be ruled out, because the CDN server load report only tracks successful queries.

If the event is detected in a report derived from the content server content access log (which reports detailed error codes for any failed sessions), any one or more of a broad range of root causes affecting customer experience may be implicated.

In one example, if the root cause relates to a device or a service that is not within the control of the CDN provider, the corrective action may comprise sending an alert to a third party who has control over the device or service. The alert may, for example, report the observed KPI values over a period of time (e.g., last x minutes, last y days, etc.) and may identify the root cause of the observed KPI values. The alert may also include a recommendation for a corrective action (e.g., increasing the size of the cache at a specific server, adding a new content server in a specific location, changing a policy for evicting content from cache, etc.) to be taken.

The method 400 may end in step 412.

In one example, the method 400 may cycle through multiple iterations. For instance, the method 400 may be repeated continuously until actively terminated by a device or by a human analyst. Thus, the customer experience within the CDN may be continuously monitored and managed as needed to maintain a desired quality or level of customer satisfaction.

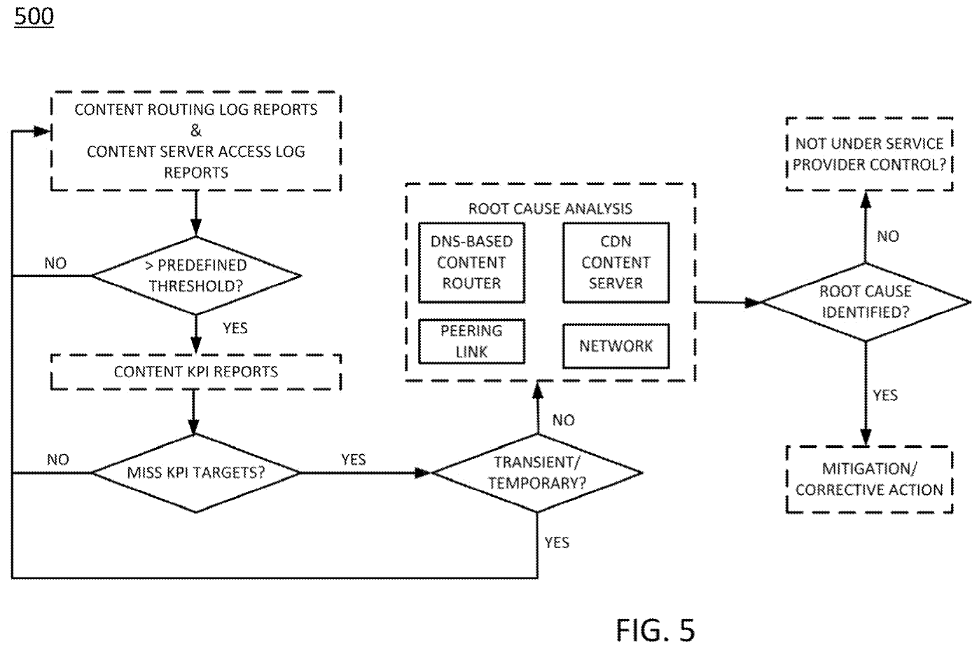

FIG. 5 illustrates an example workflow diagram 500 for predictively managing the customer experience in a content distribution network. In one example, the operations of the workflow diagram 500 may be performed by one of the application servers 114 of FIG. 1, any one or more components thereof (e.g., a processor performing operations stored in and loaded from a memory), or by an application server 114 in conjunction with one or more other devices, such as content router 274, origin server 290, server 212, and so forth.

As illustrated in FIG. 5, content routing log reports and content server access log reports may first be analyzed in order to determine whether any values associated with events detected in the content routing log reports and content server access log reports exceed a predefined threshold for the events. As discussed above, the predefined threshold for an event may be correlated with one or more KPI values which may indicate the start of a decline in the customer experience.

If no predefined thresholds are exceeded, then the content routing log reports and content server access log reports may continue to be analyzed. If, however, a predefined threshold is exceeded, then content KPI reports may be analyzed in order to determine whether any reported values for KPIs of interest have missed target values for the KPIs of interest.

If no target values for the KPIs of interest have been missed, then the content routing log reports and content server access log reports may continue to be analyzed. If, however, the target value for at least one KPI of interest has been missed, then further analysis may be performed to determine whether the missing of the target value for the at least one KPI of interest is due to a transient or temporary condition.

If the missing of the target value for the at least one KPI of interest is determined to be due to a transient or temporary condition, then the content routing log reports and content server access log reports may continue to be analyzed. If, however, the missing of the target value for the at least one KPI of interest is determined not to be due to a transient or temporary condition (i.e., is due to a more persistent condition), then the root cause analysis to determine the root cause of the target value for the at least one KPI of interest being missed is performed.

In one example, root cause analysis may identify the root cause as being related to issues with devices and/or systems that are under the control of the CDN service provider, such as issues with a DNS-based content router, a CDN content server, a network outage, or a peering link failure.

If the root cause is identified as being related to issues with devices and/or systems that are under the control of the CDN service provider, then mitigation or corrective action may be initiated as discussed above. For instance, one or more corrective actions to mitigate the issues with devices and/or systems that are under the control of the CDN service provider may be taken. If, however, the root cause is identified as being related to issues with devices and/or systems that are not under the control of the CDN service provider, then it may not be possible to initiate a corrective action. However, if the entity that is in control of the devices and/or systems is known, the entity may be informed that the devices and/or systems may potentially be experiencing issues that are affecting the customer experience.

In addition, although not expressly specified above, one or more steps of the method 300, 400, or 500 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3, FIG. 4, or FIG. 5 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 6 depicts a high-level block diagram of a computing device specifically programmed to perform the functions described herein. For example, any one or more components or devices illustrated in FIG. 1 or described in connection with the methods 300, 400, or 500 may be implemented as the system 600. As depicted in FIG. 6, the system 600 comprises a hardware processor element 602 (e.g., a microprocessor, a central processing unit (CPU) and the like), a memory 604, (e.g., random access memory (RAM), read only memory (ROM), a disk drive, an optical drive, a magnetic drive, and/or a Universal Serial Bus (USB) drive), a module 605 for predictively managing the customer experience in a content distribution network, and various input/output devices 606, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one embodiment, instructions and data for the present module or process 605 for predictively managing the customer experience in a content distribution network (e.g., a software program comprising computer-executable instructions) can be loaded into memory 604 and executed by hardware processor element 602 to implement the steps, functions or operations as discussed above in connection with the example methods 300, 400, or 500.

Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for predictively managing the customer experience in a content distribution network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

1. A method comprising:
acquiring, by a processing system including at least one processor, a system log from a component of a content distribution network;
detecting, by the processing system, an event in a report derived from the system log that has been correlated with a decline in a key performance indicator of the content distribution network, wherein the event in the report derived from the system log is correlated, prior to the acquiring, with the decline in the key performance indicator of the content distribution network using a machine learning technique; and
initiating, by the processing system, a corrective action in response to the detecting.

2. The method of claim 1, wherein the component of the content distribution network comprises a content router, and the system log comprises a content routing log.

3. The method of claim 2, wherein the report indicates a performance of the content router.

4. The method of claim 2, wherein the report indicates how content streaming requests are distributed across content server clusters of the content distribution network.

5. The method of claim 1, wherein the component of the content distribution network comprises a content server, and the system log comprises a content server content access log.

6. The method of claim 5, wherein the report indicates content download times from upstream content servers of the content distribution network to edge servers of the content distribution network.

7. The method of claim 5, wherein the report indicates why particular requests to retrieve content from content servers of the content distribution network did not perform as the particular requests were expected to performed.

8. (canceled)

9. The method of claim 1, wherein the corrective action addresses a root cause of the decline in the key performance indicator of the content distribution network.

10. The method of claim 9, wherein the key performance indicator of the content distribution network comprises a spike in video start failure.

11. The method of claim 10, wherein the event is at least one of: a spike in a load of a content router of the content distribution network, a spike in a failure rate of the content router of the content distribution network, or a spike in a load of a content server of the content distribution network.

12. The method of claim 11, wherein the root cause is determined to be at least one of: an issue with the content router of the content distribution network, an issue with the content server of the content distribution network, an outage in the content distribution network, or an issue with a peering link in the content distribution network.

13. The method of claim 9, wherein the key performance indicator of the content distribution network comprises a spike in video startup time.

14. The method of claim 13, wherein the event is at least one of: a spike in a load of a content router of the content distribution network, a spike in a failure rate of the content router of the content distribution network, a spike in a load of a content server of the content distribution network, or a spike in upstream content requests in the content distribution network.

15. The method of claim 11, wherein the root cause is determined to be at least one of: an issue with the content router of the content distribution network, an issue with the content server of the content distribution network, an outage in the content distribution network, or an issue with a peering link in the content distribution network.

16. The method of claim 9, wherein the key performance indicator of the content distribution network is a spike in exits before video start, and wherein the event is at least one of: a spike in a load of a content server of the content distribution network, a spike in upstream content requests in the content distribution network, or a spike in download time from an upstream content server of the content distribution network.

17. The method of claim 16, wherein the root cause is determined to be at least one of: an issue with the content server of the content distribution network, an outage in the content distribution network, or an issue with a peering link in the content distribution network.

18. The method of claim 9, wherein the key performance indicator of the content distribution network is a spike in rebuffering ratio, and wherein the event is at least one of: a spike in a load of a content server of the content distribution network, a spike in upstream content requests in the content distribution network, a spike in download time from an upstream content server of the content distribution network, or a presence of stale content in a cache of a content server of the content distribution network.

19. A non-transitory computer-readable medium storing instructions which, when executed by a processing system including at least one processor, cause the processing system to perform operations, the operations comprising:
acquiring a system log from a component of a content distribution network;
detecting an event in a report derived from the system log that has been correlated with a decline in a key performance indicator of the content distribution network, wherein the event in the report derived from the system log is correlated, prior to the acquiring, with the decline in the key performance indicator of the content distribution network using a machine learning technique; and
initiating a corrective action in response to the detecting.

20. A system comprising:
a processing system including at least one processor; and
a computer-readable medium storing instructions which, when executed by the processing system, cause the processing system to perform operations, the operations comprising:
acquiring a system log from a component of a content distribution network;
detecting an event in a report derived from the system log that has been correlated with a decline in a key performance indicator of the content distribution network, wherein the event in the report derived from the system log is correlated, prior to the acquiring, with the decline in the key performance indicator of the content distribution network using a machine learning technique; and
initiating a corrective action in response to the detecting.

21. The method of claim 1, wherein the acquiring the system log is performed prior to receiving an inquiry related to the decline in the key performance indicator from a customer of the content distribution network.
